(19) United States
(12) Patent Application Publication
(10) Pub. No.: US 2023/0405557 A1
(43) Pub. Date: Dec. 21, 2023

(54) MULTI-METALLIC CATALYSTS FOR PLASTIC WASTE UPCYCLING

(71) Applicant: UCHICAGO ARGONNE, LLC, Chicago, IL (US)

(72) Inventors: Magali S. Ferrandon, Steger, IL (US); Katherine McCullough, Downers Grove, IL (US); Ryan Hackler, Chicago, IL (US); Robert M. Kennedy, Chicago, IL (US); Massimiliano Delferro, Chicago, IL (US); Theodore R. Krause, Naperville, IL (US)

(73) Assignee: UCHICAGO ARGONNE, LLC, Chicago, IL (US)

(21) Appl. No.: 18/212,043

(22) Filed: Jun. 20, 2023

Related U.S. Application Data
(60) Provisional application No. 63/353,470, filed on Jun. 17, 2022.

(51) Int. Cl. B01J 23/00; B01J 23/75; B01J 23/755; B01J 23/46; B01J 35/02; C08J 11/16; C08F 10/02; C08F 8/50

(52) U.S. Cl. CPC B01J 23/002; B01J 23/75; B01J 23/755; C08F 8/50; B01J 35/023; C08J 11/16; C08F 10/02; B01J 23/462

(57) ABSTRACT

A method of upcycling polymers to useful hydrocarbon materials. A catalyst with nanoparticles on a substrate selectively docks and cleaves hydrocarbon chains forming shorter hydrocarbon chains. The catalyst includes metal nanoparticles, such as monometallic nickel or ruthenium nanoparticles or a plurality of nanoparticles of two or more metals, on a metal oxide substrate.

### CROSS REFERENCE TO RELATED APPLICATIONS

This application claims priority to and the benefit of U.S. Provisional Patent App. No. 63/353,470, filed Jun. 17, 2022, the content of which is incorporated by reference in its entirety. The present application incorporates by reference U.S. Prov. Pat. App. No. 62/796,482 filed Jan. 24, 2019, and U.S. patent application Ser. No. 16/749,885 filed as a non-provisional thereto on Jan. 22, 2020, as well as U.S. Prov. Pat. App. No. 62/892,347 filed Aug. 27, 2019, and U.S. patent application Ser. No. 17/018,702 filed as a non-provisional thereto on Aug. 24, 2020.

### STATEMENT OF GOVERNMENT SPONSORSHIP

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to multi-metallic catalysts and a hydrogenolysis process using same catalyst that selectively converts plastics into other hydrocarbon products.

### BACKGROUND

Synthetic polymers have quickly become engrained in everyday use. In particular, those polymers—commonly referred to as plastics—have become a ubiquitous part of modern consumer culture, consuming a large amount of global resources and generating a large amount of waste materials. The three hundred million tons of plastics that are created and discarded annually consume 6.8% of the crude oil and natural gas produced worldwide. In the United States alone, thirty million tons of polymers are produced each year; 75% of these materials are discarded to landfill after a single use.

In light of both the large drain on global resources and the massive amount of waste material generated, plastics represent a tremendous and as-yet-untapped domestic resource for the production of chemicals and new materials. Efficient technologies for extracting this value from discarded polymers would be equivalent to recovering about 3.5 billion barrels of oil ($175 billion at $50/barrel, $350 billion at $100/barrel) each year and could create entirely new industries. Currently, most of the stored energy in plastics is irreversibly lost into landfills that are overflowing throughout our planet. While physical recycling is desirable and widespread in many areas for a wide range of materials, it is most effective for recovering glass, paper, and metals such as aluminum. Recycling, to-date, has not be able to efficiently and cleanly recoup the inherent value in plastics, especially low-density polyethylene (plastic bags), polypropylene, and polystyrene. As a result, many plastics are just burned as fuel or inefficiently reprocessed to manufacture lower-value materials (known as downcycling). Plastics are expensive, highly engineered materials that are wasted as boiler fuel. Existing deconstruction approaches can convert the macromolecules into smaller fragments, but the result is an extremely broad distribution of lighter hydrocarbons whose low value makes them much less useful than virgin fossil fuels and petrochemicals.

Prior work has developed processes to utilize waste plastic as a feed stock, see, e.g., U.S. patent application Ser. No. 16/749,885, U.S. patent application Ser. No. 17/000,969, and U.S. patent application Ser. No. 17/018,702, each incorporated herein by reference.

While existing catalysts have been identified that provide catalytic activity to dock and cleave long chain hydrocarbons into smaller chained products, such known catalysts exhibit undesirable attributes. For example, existing catalysts may not provide a high yield of desired resultant molecular weight product or a dispersity (“PDI”).

### SUMMARY

Embodiments described herein relate generally to a method of upcycling a polymer into a more valuable product. The method includes exposing the polymer to catalyst at a temperature of 100° C. to 500° C., reacting the polymer on the catalyst comprising an of subnanoparticles, nanoparticles or clusters on a crystalline substrate or amorphous metal oxide and cleaving carbon-carbon bond of the polymer to a narrower distribution of hydrocarbons such as wax or lubricants. A plurality of hydrocarbon fragments having a carbon backbone are formed from this cleaving.

In some embodiments, a catalyst comprising of one or a plurality of metal (sub)nanoparticles clusters, onto metal oxide substrate such as a perovskite substrate alumina, ceria, titania, and zirconia.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 illustrates an example reaction pathway for the synthesis of a bi-metallic catalyst.

FIG. 2 is a graph of molecular weight relative intensity for three different single metallic catalysts on strontium titanate (“STO”) substrate, Ni, Ru, and Pt.

FIGS. 3A-3F illustrate high-angle annular dark field (“HAADF”) of a CoNi on Al₂O₃ catalyst after reduction at 400° C. for 4 hours in a 10% hydrogen environment; FIG. 3A is a HAADF image, FIGS. 3B-3F illustrate EDS elemental mapping, where FIG. 3B illustrates nickel presence; FIG. 3C illustrates aluminum presence; FIG. 3D illustrates oxygen presence; FIG. 3E illustrates cobalt presence; and FIG. 3F illustrates the presence of both nickel and cobalt.

FIG. 4A illustrates the screening results for a range of different catalysts, comprising eight different mono-metallic catalysts (Ni, Co, Cr, Cu, Mn, Fe, Ga, and In) as well as combinations of a first metal of Ni, Co, Cr, Cu, Mn, Fe, Ga, or In and a second metal of Ni, Zr, Ru, Rh, Pt, Pd, Mn, Ir, In, Ga, Fe, Cu, Cr, Co, or Ag. The average molecular weight (Mn) of the resultant product indicated is indicated by the shading, note where the first metal and second metal are listed as the same metal, the resultant material is monometallic. FIG. 4B illustrates the screening results for eight different metals as the first metal and fifteen different metals as the second metal with the polydispersity of the resultant product indicated.

FIGS. 5A-5B show the results of three reactions. FIG. 5A shows the results of a control reaction under the following conditions: no catalyst, medium-density polyethylene (“MDPE”) (Sigma-Aldrich, Mₙ=2.8 kDa, M_{w}=4 kDa, 3 g), 300° C., 180 psi mixed gas (90% H₂+10% He), 24 hours. FIG. 5B shows the results of two reactions under the following conditions: MDPE (Sigma-Aldrich, Mₙ=2.8 kDa, M_{w}=4 kDa, 3 g), Ni/Co/Al₂O₃ (50 mg), 180 psi mixed gas (90% H₂+10% He). One reaction was run at 280° C. for 48 hours, and the other was run at 300° C. for 24 hours.

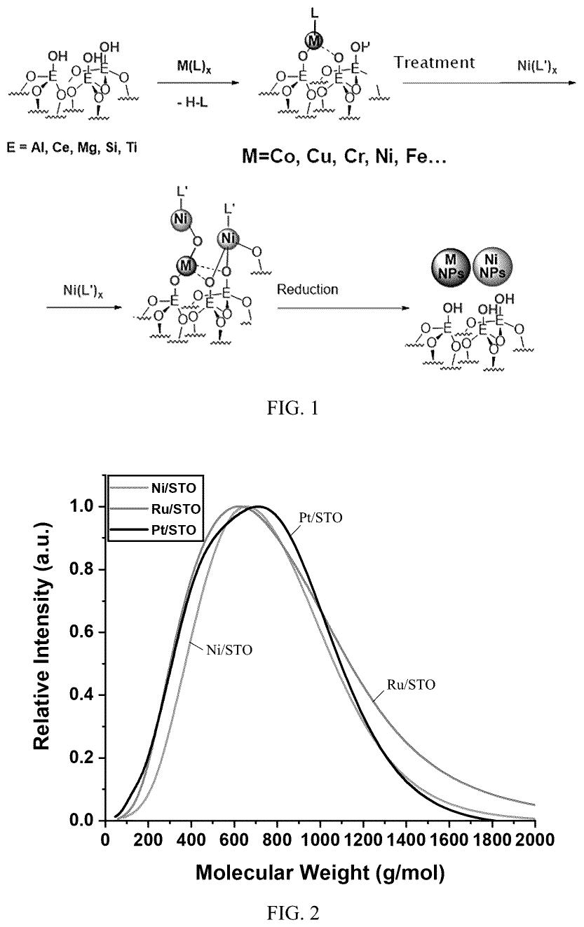

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Multifunctional catalysts must be able to (i) induce docking of a polymer chain at a specific location, (ii) control the configuration of the adsorbed chain on the surface of the catalyst, and (iii) cleave a certain bond at a precise position along the chain to deconstruct hydrocarbon polymers efficiently into fragments of relatively uniform size. Described herein are alternative processes for polymer conversion with multifunctional catalysts that selectively convert polymers (plastics) into more valuable, narrowly distributed products, such as lubricants, waxes, and the like.

Specifically, metal nanoparticles are supported on the surface of support material forming effective catalysts for converting polymers to smaller fragments. These smaller fragments refer to fragments having a size, typically expressed in terms of carbon backbone length of the fragment. Various catalysis parameters, including the metal particle size, composition, and loading method of the sub-nanoparticles/nanoparticles/clusters, the composition of the support (chemical composition, interfacial energy with the catalyst particles, surface acidity/basicity, surface area/porosity/tortuosity, and size), and catalyst loading all appear to have an effect on the fragment size. The metal nanoparticle catalysts promote carbon-carbon bond cleaving in presence of hydrogen (hydrogenolysis), for example through a “chopping” approach wherein the polymer is docked and cleaved.

The metal nanoparticles may be formed by a deposition process, such as surface organometallic chemistry (“SOMC”), known as metalation, strong electrostatic adsorption (“SEA”), incipient wetness (“IW”) or Atomic Layer Deposition (“ALD”). For example, ALD is performed in a viscous flow reactor to form metal nanoparticles (mono-metallic or multi-metallic depending on the embodiment). The general ALD process used to prepare experimental examples is as follows. Powder samples were placed inside the ALD chamber under vacuum (base pressure=0.05 Torr) and heated to 200° C. An ALD precursor was used as the metal source with ultrahigh purity (“UHP”) N₂ as the carrier gas (in some experiments at 50 sccm). An ozone generator (using UHP O₂ source, 99.99%) was utilized for the ozone source. The timing sequence for ALD was 300 s-300 s-300 s-300 s static dosing, where the valve to the vacuum was shut off during the dose step. The precursor bubbler was heated to 65° C. and the precursor inlet line was heated to 75° C. A pre-treatment of the powder sample was performed where the sample was held under constant ozone exposure at 200° C. for 2 hours followed by pulses of water. For embodiments where a multi-metallic nanoparticle is formed, a metalation process may be used. While the term nanoparticles is used here, it should be appreciated that in some embodiments, nanoparticles encompass subnanoparticles (below 1 nm), nanoparticles (1-100 nm) or clusters of either or both.

As described further below, catalytic materials provide for spatial arrangement of docking and cleaving sites, providing for a controllable synthetic mechanism for cleaving polymers. As used herein, “docking” and “chopping”/“cleaving” are defined as a form of catalytic cooperativity facilitate the described polymer breakdown. Catalysts that identify and cleave specific bonds at precise positions along a macromolecular chain (polymer, plastic) will be able to convert hydrocarbon polymers efficiently into relatively uniform fragments.

The support material is comprised of a metal oxide support, which may be crystalline or amorphous metal oxides. The support material, in one embodiment, is selected from the group of metal oxides comprising: alumina, titania, strontium titanate, ceria, silica-aluminate, zirconia, and magnesia. In one embodiment, the support material is a crystalline nanocuboid and is a single-phase material that is non-reactive with the desired hydrocarbons to be processed. For example, the support material may be a perovskite, for example a perovskite selected from the group consisting of strontium, barium, and calcium titanate or other perovskites with general formula ABO₃, or those that are oxygen-deficient, ABO₃₋ₓ where x is in the range 0≤x≤0.5. The morphology of the nanocuboid phase, which is the support for the metal nanoparticles, such as platinum, adopts and mirrors the cubic crystal structure of the perovskite which ranges from a=3.5−4.2 Å and is on average a cube of about a=4.0 Å. This unit cell contains one A-cation, one B-cation, and three oxygen anions (ABO₃). A typical nanocuboid of SrTiO₃ is terminated with the TiO₂ atomic layer exposed, although SrO is also possible. For example, these TiO₂ layers terminate all six surfaces of the nanocuboids. The nanocuboids that are crystallized from the solution can vary in size, however cubes 30-αnm (300-600 Å) are used to maintain specific surface area. For example, a typical nm (400 Å) nanocuboid, that is a small cube 40 nm×40 nm on a side has six surfaces, each 1600 nm² in area, on which the many platinum nanoparticles nucleate with the interparticle spacing depending on the ALD deposition conditions.

For embodiments with a crystalline metal oxide, the metal nanoparticles and support may be selected such that they have approximately, i.e., the same facet, the same lattice constants creating an epitaxial arrangement of the atoms which stabilizes the interface between the two phases creating a stable catalyst, with the metallic catalyst dispersed on the surfaces of the support nanocuboids. The crystalline surfaces of the support materials, for example perovskite, will provide a foundation for ordered arrays of nanoparticles, thus providing an ordered array of catalytic sites. When the particles are sufficiently small (˜50 nm), large surface areas (˜20 m²/g) can also be achieved. Large surface areas allow for high loadings of catalysts to be supported onto these surfaces modified with new structural features and functionalities. STO nanocuboids {001} or rhombic dodecahedral nanoparticles {110} are synthesized solvothermally under basic conditions giving TiO₂-terminated surfaces.

The support material may further be a hybrid material comprising a high surface area support material that is amorphous (with a perovskite, such as STO, added thereto). In one embodiment, the metal nanoparticles are arranged in an ordered fashion on the crystalline substrate, with an interparticle spacing spanning from approximately 3.5 nm to 6.5 nm, tuned based on the deposition parameters, including precursor contact time, number of metal deposition cycles, metal precursor, and temperature.

The hydrogenolysis cleaves a carbon-carbon bond in the polymer to create smaller fragments. Feedstock for the process may be unsorted polymer materials, such as commonly used consumer plastics, or may be sorted materials to provide a common polymer as feedstock and result in a consistent hydrocarbon fragment. The catalytic material includes both docking and chopping sites. The docking site helps the polymer to stay close (bounded) to the catalytic active sites (the chopping sites) and not diffuse in the reaction media. A docking site can be also a chopping site, such as where both are the catalytic metal nanoparticle.

In one embodiment, the polydispersity is desired to be as close to 1 as practical to minimize the range of products. For example 1-3, including 1-2, 1-1.8, 1-1.6, 1-1.4 and ranges in between).

In one embodiment, process facilitates the carbon-carbon bond cleavage of waste polymers such as low- and high-density polyethylene and propylene a by selective catalytic hydrogenolysis into a distribution centered ˜C₁₀₀ fragments. In one embodiment, the fragments are free of low boiling point alkanes, such as methane, ethane, and butane. Notably, this is the opposite behavior of the Zr@SiO₂Al₂O₃ catalysts (see, e.g., Basset, J.-M Angew. Chem. Int. Ed. 1998, 37, 806-810).

### Mono-Metallic Metal Catalysts

In one embodiment, the metal nanoparticles may be selected from the group consisting of Ru, Ni, Co, Cr, Cu, Mn, Fe, Ga, and In, where the catalyst comprises a mono-metallic structure. That is, the catalyst includes a single metal. The mono-metallic catalysts must be able to (i) induce docking of a polymer chain at a specific location, (ii) control the configuration of the adsorbed chain on the surface of the catalyst, and (iii) cleave a certain bond at a precise position along the chain to deconstruct hydrocarbon polymers efficiently into fragments of relatively uniform size.

In one embodiment, the mono-metallic nanoparticles are deposited onto a metal oxide support (such as but not limited to alumina, titania, strontium titanate, ceria, silica-aluminate, zirconia, magnesia.). For example, the mono-metallic nanoparticles may be deposited on a strontium titanate (“STO”) support through liquid-phase deposition, producing 1-2 nm particles. The catalysts are active for the hydrogenolysis of polyethylene, producing a mixture of liquids and gases. The mono-metallic catalysts may operate in a temperature range of 100-500° C. and a 5%-100% hydrogen environment with a pressure of 50-500 psi. The final loadings of metals can vary between 0.5 and 20 wt. % of the total catalyst weight.

### Ru Catalyst and Ni Catalyst Experimental Results

The Ru/STO and Ni/STO catalysts are prepared by formation of the respective nanoparticles, subnanoparticles or cluster. In a particular embodiment, the nanoparticles have an average size of 5 nm±4 nm. The nanoparticles may be deposited by atomic layer deposition (“ALD”) by a process as described above. The nanoparticles are by liquid-phase surface organometallic chemistry (“SOMC”) as described further herein. This process produced catalysts having 1-2 nm nanoparticles with 0.2 to 0.4 wt % of the respective metal relative to rest of the catalyst. Ru and Ni catalysts: they were deposited using acetylacetonate salts at 80° C. over 72 hours in a solution containing toluene. The suspensions were washed with toluene to remove the unreacted metal salt and pentane was used for solvent exchange. All this was done in a glovebox to keep air and moisture-free environment. The catalysts were then dried overnight at 80° C. followed by reduction in 10% H₂ in inert at 400° C. for 4 hours.

Commercial polyethylene (Mₙ=7.8 kD, Ð=3.1) under H₂ (170 psi) with Ru/STO and Ni/STO at 300° C. for 72 hours gives full conversion to the chopped product FIG. 2 illustrates a comparison under essentially identical conditions for Ni/STO, Ru/STO, and Pt/STO catalysts for processing polyethylene. Polyethylene converted by Pt-, Ru-, and Ni-based catalysts produce nearly identical products. Ru/STO yielded only 17% liquids with the rest being gas. In contrast, Ni/STO yielded 34% liquid with the rest being gases.

### Multi-Metallic Catalysts

In some embodiments, the catalyst comprises a multi-metallic structure. That is, the catalyst includes two or more metals. The multi-metallic catalysts must be able to (i) induce docking of a polymer chain at a specific location, (ii) control the configuration of the adsorbed chain on the surface of the catalyst, and (iii) cleave a certain bond at a precise position along the chain to deconstruct hydrocarbon polymers efficiently into fragments of relatively uniform size.

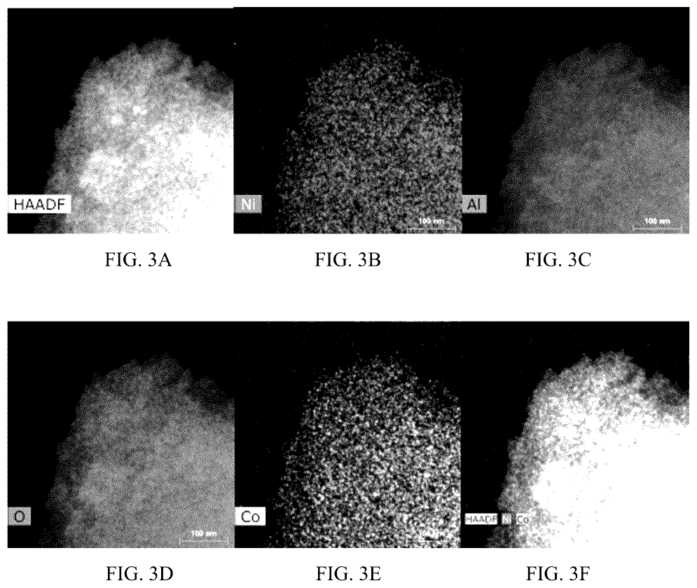

Specifically, multi-metallic nanoparticles supported on a metal oxide material such as perovskites or alumina are effective catalysts for reducing polymers to smaller fragments. FIG. 3 illustrates an example of the two-step synthesis of a bi-metallic catalyst.

The catalyst consists of multi-metallic nanoparticles of two or more transition metals, other metals, and rare earth elements, deposited onto of formed on a metal oxide support, such as but not limited to alumina, titania, strontium titanate, ceria, silica-aluminate, zirconia, and magnesia. The nanoparticles may comprise two or more metals such as first metal of Ni, Co, Cr, Cu, Mn, Fe, Ga or, In. The second metal may be selected from Ag, Co, Cr, Cu, Fe, Ga, In, Mn, Pd, Pt, Rh, Ru, Zr, and Ni. Preferably, the nanoparticles are bimetallic with a composition of Cu/Cr, Pd/Cr, Co/Ni, Fe/Cu, Ir/Cu, Zr/Ga, or Cu/In (second metal/first metal). The nanoparticles can be separated or interacted with each other to form an alloy. A co-deposition would favor the deposition of one element over the other. In some embodiments, the deposition is sequential to avoid such an issue for multimetallic deposition.

The catalyst is synthesized using various deposition techniques (deposition-precipitation, surface organometalic chemistry (“SOMC”), known as metalation, strong electrostatic adsorption (“SEA”), incipient wetness (“IW”), ALD or the like), which produces nearly uniform metal (sub)nanoparticles or clusters. The metal precursors can be co-deposited, or sequentially with or without a pre-treatment (calcination, reduction...) in between. The catalysts are reduced in H₂ or mixture of H₂ and inert temperature between 200 and 500° C. The final loadings of metals can vary between 0.5 and 20 wt. % of the total catalyst weight.

In one embodiment, the process includes, and the catalyst facilitates, hydrogenolysis. The catalytic process for multi-metallic catalysts described herein may utilize a lower amount of energy, reflected in a lower temperature, such as between 100 and 500, well as a lower pressure, such as between 50 and 500 psi.

### Multi-Metallic Catalyst Experimental Results

Screening was undertaking of 200+ catalysts for their ability to produce fragments. While platinum and platinum group catalysts are known for their general catalytic activity and specifically their ability to produce, relative to others, narrow distribution ranges (low polydispersity) and small fragment sizes (desirable for lubrication purposes for example), such catalysts also present drawbacks including cost, sourcing, etc.

As one particular example of a multi-metallic catalyst, a cobalt and nickel catalyst on an alumina substrate was analyzed under HAADF. FIGS. 3A-3F illustrate high-angle annular dark field (“HAADF”) of a CoNi on A₂O₃ catalyst after reduction at 400° C. for 4 hours in a 10% hydrogen environment; FIG. 3A is a HAADF image of the overall catalyst material; FIG. 3B illustrates nickel content; FIG. 3C illustrates aluminum content; FIG. 3D illustrates oxygen content; FIG. 3E illustrates cobalt content; and FIG. 3F illustrates the content of both nickel and cobalt.

In one embodiment, a first metal is deposited, is deposited by metalation, such as using acetylacetonate salts at 80° C. over 72 hours in a solution containing toluene. The resulting suspensions is then washed, such as with toluene, to remove the unreacted metal salt. A solvent exchange is performed, such as using pentane. This process may be performed in a controlled embodiment, such as a glovebox to keep air and moisture-free environment. The catalysts were then dried, such as overnight at 80° C. A similar process is followed for the second metal to be deposited by metalation. The final bimetallic catalyst would be then reduced at 200-500° C.

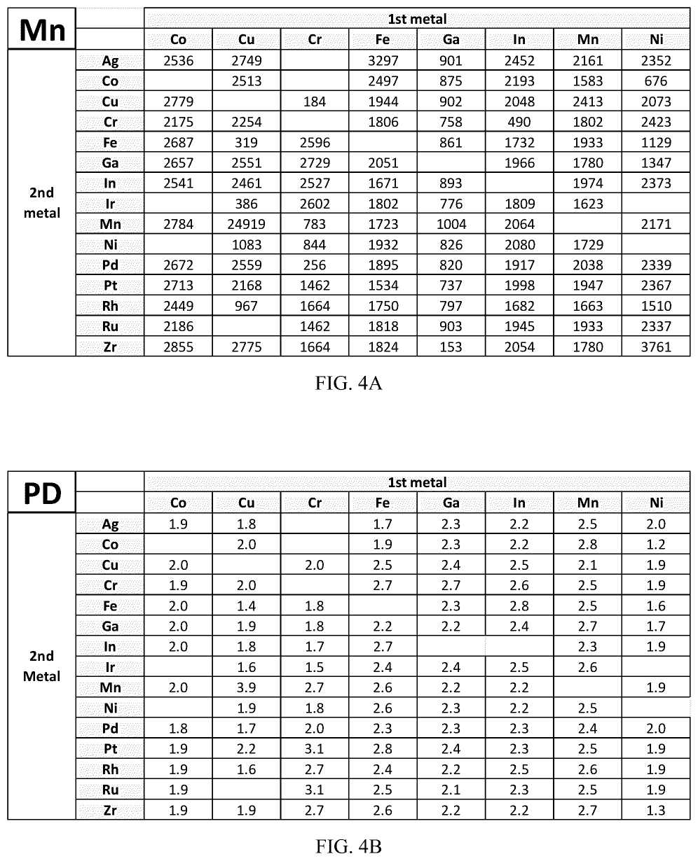

FIG. 4A illustrates the screening results for eight different metals as the first metal and fifteen different metals as the second metal with the average Mn of the resultant product indicated with a starting Mn of 1,700 Da; FIG. 4B illustrates the screening results for eight different metals as the first metal and fifteen different metals as the second metal with the polydispersity of the resultant product indicated. As can be seen in the figures, there are seven catalysts that provide low Mn (for purposes of this embodiment, molecular weight of <700 g/mol) as well as exhibiting low polydispersity approaching the lower end of the range (<1.5): Cu/Cr, Pd/Cr, Co/Ni, Fe/Cu, Ir/Cu, Zr/Ga, and Cu/In. Notably, Co/Ni catalyst was shown to have a very low (that is close to 1) polydispersity. Co/Ni show highly dispersed subnanoclusters after reaction (FIGS. 3A-3F) indicating that there was no agglomeration of metals that usually lead to deactivation of the catalysts. The results indicate that the catalysts enable improved performance over existing materials at lower pressures and temperatures.

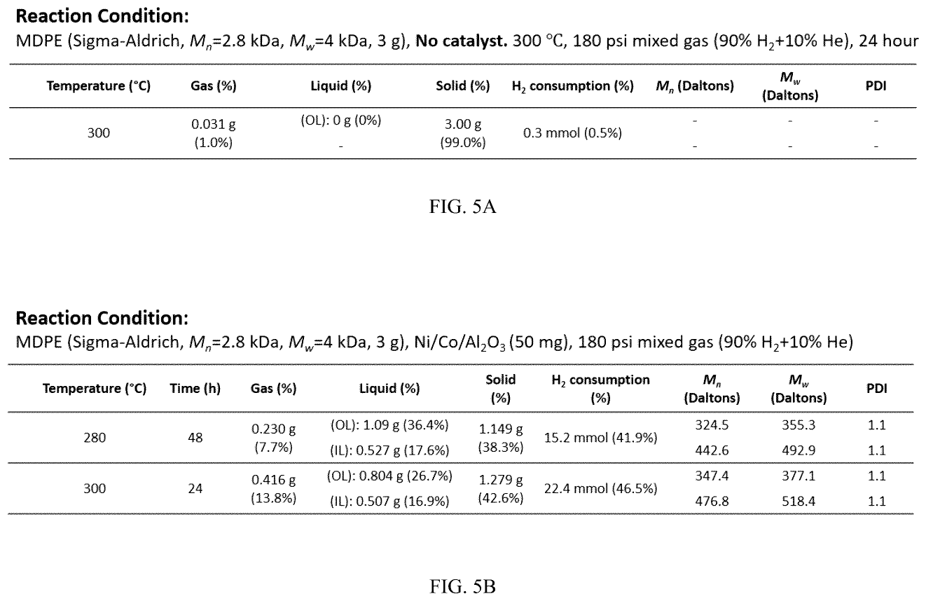

FIGS. 5A-5B show the results of three reactions illustrating a control compared to a Ni/Co/Al₂O₃ multi-metallic catalyst. FIG. 5A shows the results of a control reaction under the following conditions: no catalyst, medium-density polyethylene (“MDPE”) (Sigma-Aldrich, Mₙ=2.8 kDa, M_{w}=4 kDa, 3 g), 300° C., 180 psi mixed gas (90% H₂+10% He), 24 hours. FIG. 5B shows the results of two reactions under the following conditions: MDPE (Sigma-Aldrich, Mₙ=2.8 kDa, M_{w}=4 kDa, 3 g), Ni/Co/Al₂O₃ (50 mg), 180 psi mixed gas (90% H₂+10% He). One reaction was run at 280° C. for 48 hours, and the other was run at 300° C. for 24 hours.

### Definitions

As used herein, number averaged molecular weight, which is equivalent to average or mean and sensitive to light molecules:

$${M}_{n} = \frac{Σ {M}_{i} {N}_{i}}{Σ {N}_{i}}$$

As used herein, weight average molecular weight, sensitive to heavy molecules:

$${M}_{w} = \frac{Σ {M}_{i}^{2} {N}_{i}}{Σ {M}_{i} {N}_{i}}$$

As used herein, dispersity (PDI) is a measure of heterogeneity:

Ð=(M_{w})/(Mₙ)

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A catalyst comprising:
a substrate selected from the group consisting of silica, alumina, titania, strontium titanate, ceria, silica-aluminate, zirconia, and magnesia; and
a plurality of metal nanoparticles disposed on the substrate, the metal nanoparticles comprising a first metal of Ni, Co, Cr, Cu, Mn, Fe, Ga or, In; and a second metal selected from Ag, Co, Cr, Cu, Fe, Ga, In, Mn, Pd, Pt, Rh, Ru, Zr, and Ni;
wherein the plurality of metal nanoparticles is between 0.5 and 20 wt. % of total catalyst weight.

2. The catalyst of claim 1, wherein the plurality of metal nanoparticles are selected from the group comprising of Cu/Cr, Pd/Cr, Co/Ni, Fe/Cu, Ir/Cu, Zr/Ga, and Cu/In.

3. The catalyst of claim 2, wherein the plurality of nanoparticles comprise Co/Ni.

4. The catalyst of claim 1, wherein the substrate is a perovskite.

5. The catalyst of claim 1, wherein first metal and the second metal are co-deposited on the substrate.

6. A catalyst comprising:
a substrate selected from the group consisting of silica, alumina, titania, strontium titanate, ceria, silica-aluminate, zirconia, and magnesia; and
a plurality of metal nanoparticles disposed on the substrate, the metal nanoparticles comprising a first metal of Ru or Ni;
wherein the plurality of metal nanoparticles is between 0.5 and 20 wt. % of total catalyst weight.

7. The catalyst of claim 6, wherein the metal nanaoparticles consist essentially of Ru.

8. The catalyst of claim 6, wherein the metal nanaoparticles consist essentially of Ni.

9. The catalyst of claim 6, wherein the metal nanoparticles are subnanoparticles. The catalyst of claim 6, wherein the metal nanoparticles have an average size of 5 nm±4 nm.

11. The catalyst of claim 6, wherein the substrate is strontium titanate.

12. A method of forming a catalyst comprising:
providing a substrate selected from the group consisting of silica, alumina, titania, strontium titanate, ceria, silica-aluminate, zirconia, and magnesia; rate;
forming a plurality of metallic nanoparticles on the substrate, the nanoparticles comprising a first metal and a second metal;

13. The method of claim 12, wherein forming the plurality of metallic nanoparticles comprises sequentially depositing the first metal and then the second metal.

14. The method of claim 12, wherein forming the plurality of metallic nanoparticles comprises co-depositing the first metal and then the second metal. The method of claim 12, wherein the first metal is selected from the group consisting of Ni, Co, Cr, Cu, Mn, Fe, Ga or, In; and the second metal is selected from the group consisting of Ag, Co, Cr, Cu, Fe, Ga, In, Mn, Pd, Pt, Rh, Ru, Zr, and Ni.

16. The method of claim 12, wherein forming the plurality of metallic nanoparticles comprising forming a bimetallic plurality of nanoparticles selected from the group consisting of Cu/Cr, Pd/Cr, Co/Ni, Fe/Cu, Ir/Cu, Zr/Ga, and Cu/In.

17. The method of claim 12, wherein the first metal and the second metal are both Ni.

18. The method of claim 12, wherein the first metal and the second metal are both Ru.

19. The method of claim 12, wherein the substrate is a nanocuboid substrate.

20. The method of claim 12, wherein the nanoparticles are anchored to the nanocuboid substrate at exposed undercoordinated metal centers of the nanocuboid crystalline structure.
